(19) United States
(12) Patent Application Publication
(10) Pub. No.: US 2006/0021269 A1
(43) Pub. Date: Feb. 2, 2006

(54) Sheet material display assembly

(76) Inventor: Michael Doctoroff, Natick, MA (US)

Correspondence Address: John E. Toupal, 116 Concord Street, Framington, MA, 01702, US

(21) Appl. No.: 10/900,118

(22) Filed: Jul. 28, 2004

(51) Int. Cl. G09F 7/22

(52) U.S. Cl. 40/617

(57) ABSTRACT

A hanger for display sheets and including a frame having an upper edge defining a first slot and a second slot spaced from the first slot; at least one of the slots having an entrance portion extending downwardly from the upper edge, an intermediate portion extending in a given direction from the entrance portion, and a terminal portion extending from the intermediate portion upwardly toward the upper edge. Also included is a securing mechanism for attaching display sheets to the frame.

### BACKGROUND OF THE INVENTION

This invention relates generally to a hanger for multiple display sheets and, more particularly, to a frame for supporting flip charts.

Flip charts are used frequently during presentations of various types. The charts typically consist of a plurality of display sheets retained at one edge by a binding. During a presentation, the charts are mounted on a suitable support structure and selectively flipped to expose the display on individual sheets. Because of their significant size and bulk, handling and storage of flip charts can be cumbersome and time consuming.

The object of this invention, therefore, is to provide an improved flip chart hanger system which simplifies handling and storage of the charts.

### SUMMARY OF THE INVENTION

The invention is a hanger for display sheets and includes a frame having an upper edge defining a first slot and a second slot spaced from the first slot; each of the slots having an entrance portion extending downwardly from the upper edge, an intermediate portion extending in a given direction from the entrance portion, and a terminal portion extending from the intermediate portion upwardly toward the upper edge. Also included is a securing mechanism for attaching display sheets to the frame. The hanger simplifies both storage of flip charts and handling thereof during presentations.

According to one feature of the invention, each of the slots is shaped and arranged to receive a support member projecting transversely to the frame. The slots facilitate mounting of flip charts on support brackets.

According to another feature of the invention, the frame is elongated in the given direction and the slots are disposed adjacent opposite ends thereof. The elongated frame with spaced slots enhances stability of the flip charts during use.

According to another feature of the invention, the securing mechanism includes a pair of securing devices spaced apart in the given direction. This feature facilitates stable mounting of a flip chart pad on the frame.

According to a further feature, the invention encompasses a support system including for the above described hanger, a stand supportable on a support surface and an upper portion having first and second parallel bracket rods for insertion into the first and second slots of the hanger. The stand facilitates display of flip charts in a desired location.

### DESCRIPTION OF THE DRAWINGS

These and other objects and features of the invention will become more apparent upon a perusal of the following description taken in conjunction with the accompanying drawings wherein:

FIG. 1 is a perspective view of a flip chart support system according to the invention;

FIG. 2 is a perspective view of a hanger mechanism in the system of FIG. 1;

FIG. 3 is a top view of the hanger mechanism shown in FIG. 2;

FIG. 4 is a rear view of the hanger mechanism shown in FIG. 2;

FIG. 5 is a right end view of the hanger mechanism shown in FIG. 2;

FIGS. 6-9 are sequential views illustrating assembly of the system shown in FIG. 1;

FIG. 10 is a partial cross-sectional view of the system shown in FIG. 1; and

FIG. 11 is a view illustrating mounting of a flip chart pad on the hanger mechanism shown in FIGS. 2-5.

### DESCRIPTION OF THE PREFERRED EMBODIMENT

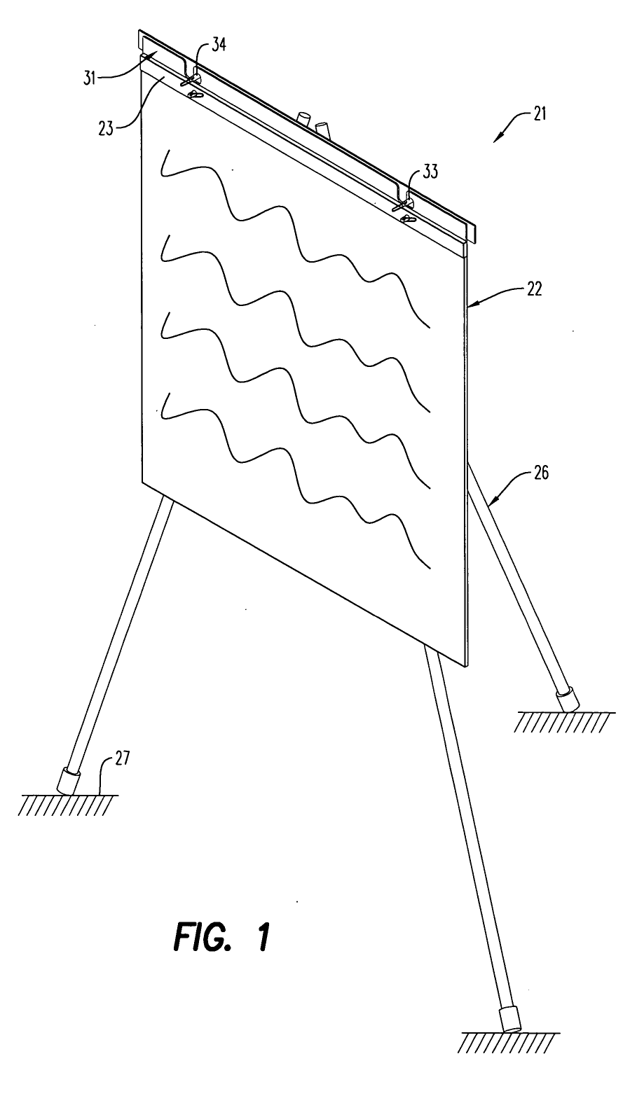

A support system 21 for a flip chart pad 22 consisting of a plurality of display sheets joined along one edge to a binding 23 is illustrated in FIG. 1. Included in the system 21 is a tripod easel 26 supported on a surface 27. The pad 22 is mounted on a hanger 31 as described hereinafter. Supporting the hanger 31 are first and second parallel bracket rods 33, 34 of the system 21. The rods 33, 34 lie in a plane substantially parallel to the support surface 27.

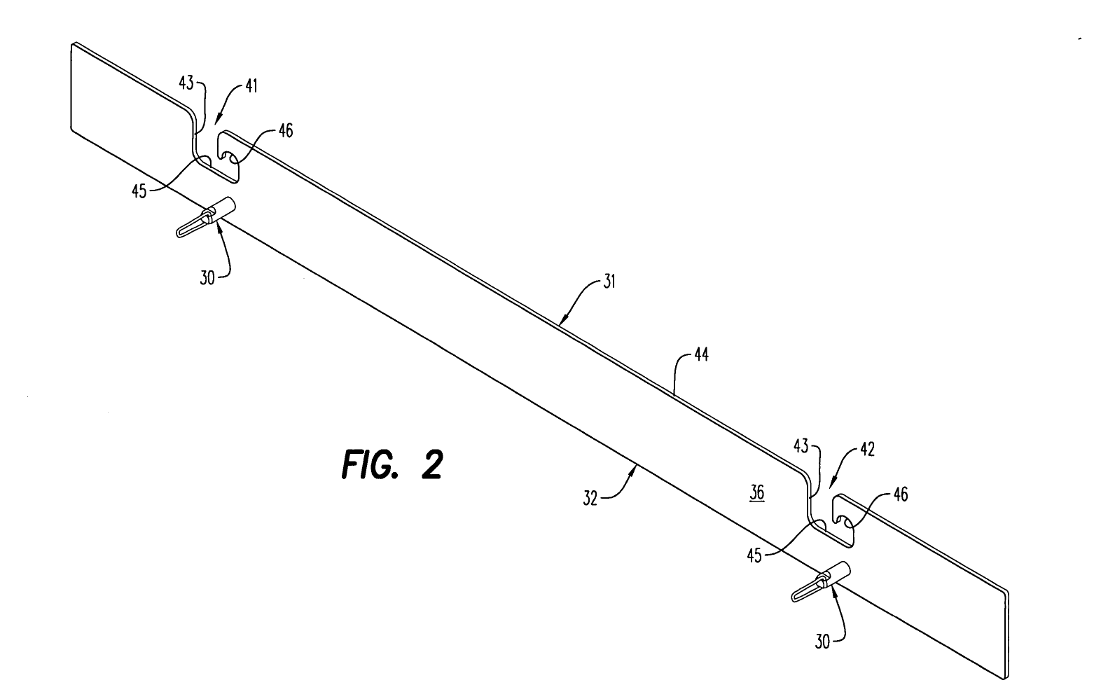

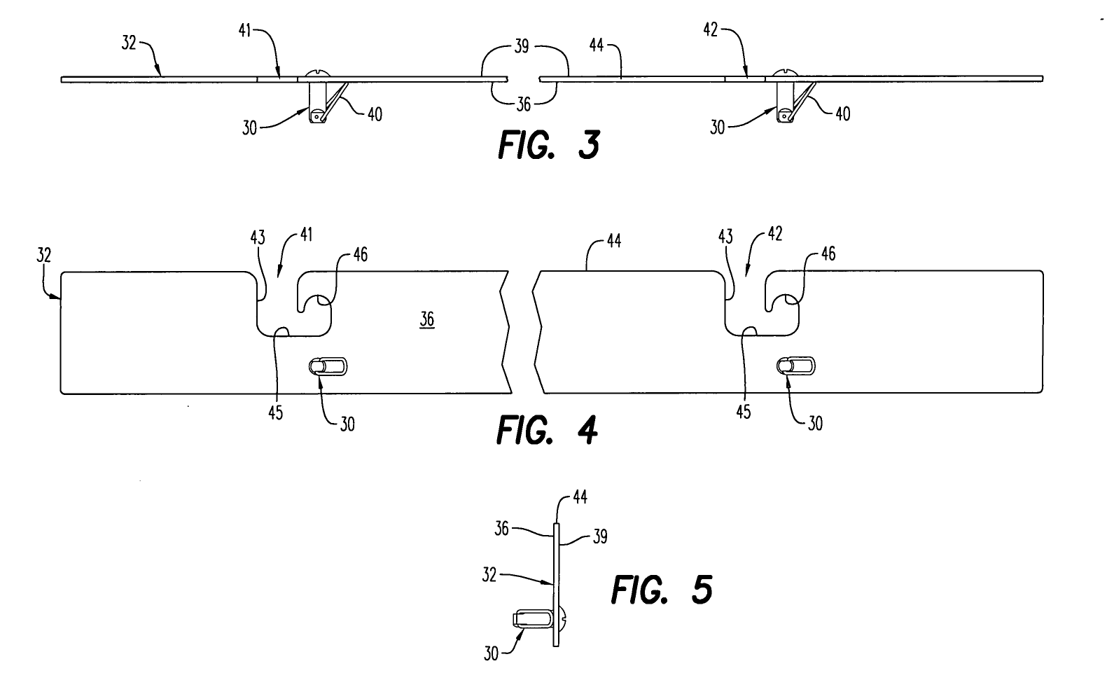

FIGS. 2-5, 10 and 11, depict the hanger 31 which includes an elongated frame 32 and a pair of securing devices 30 for attaching the flip chart pad 22 to the frame 32. The devices 30 each consist of a shank portion 35 engaging a front surface 36 of the frame 32 and a screw 37 extending through an aperture in the frame 32 and having a screw head 38 engaging a rear surface 39 of the frame 32. An outer end of each shank portion 35 retains a pivotable clamp 40. Further details of the securing devices 30 are disclosed in U.S. patent application Ser. No. 10/783,930 filed Feb. 20, 2004 and entitled COMBINED CLAMP AND RETAINING PIN.

Defined by the elongated frame 32 are first and second longitudinally spaced apart slots 41 and 42. Each slot 41, 42 includes an entrance portion 43 extending downwardly from an upper edge 44 of the frame 32, an intermediate portion 45 extending in a given direction from the entrance portion 43 and a terminal portion 46 extending from the intermediate portion 45 upwardly toward the upper edge 44.

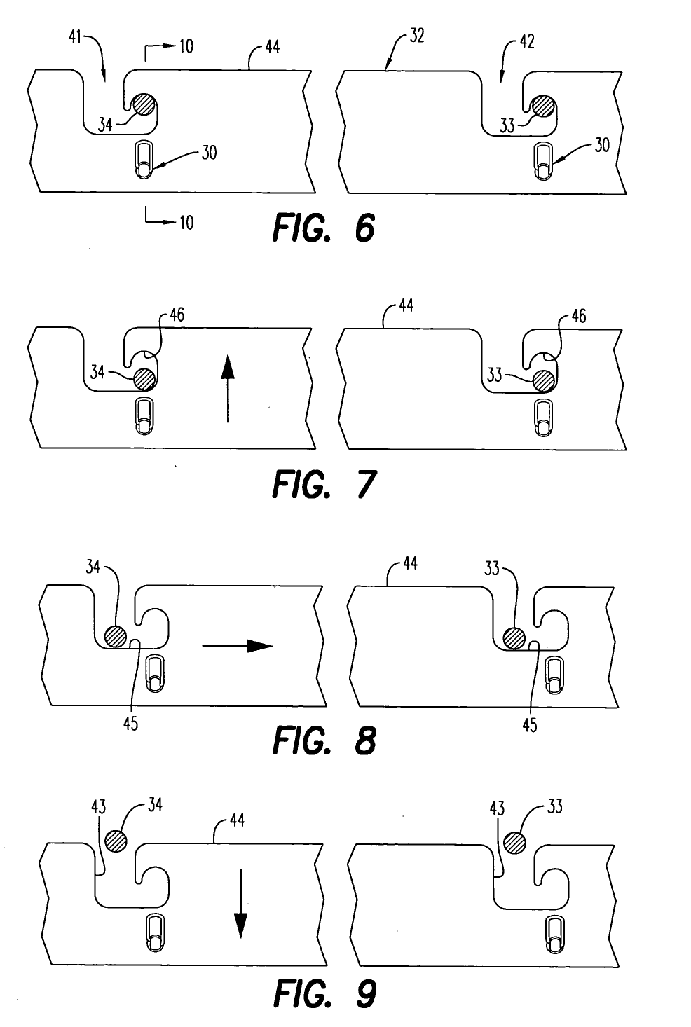

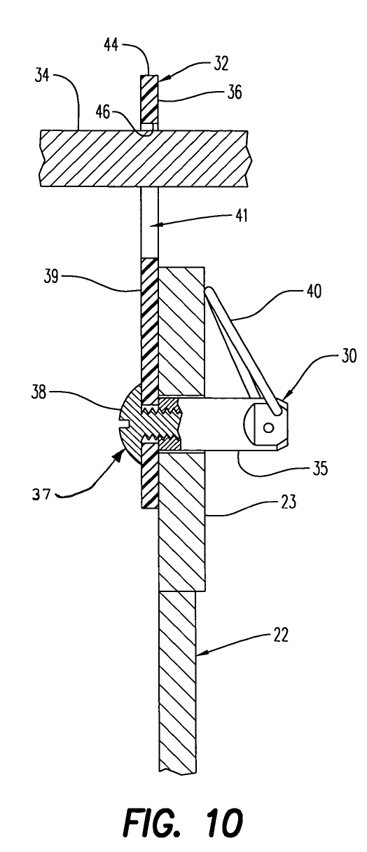

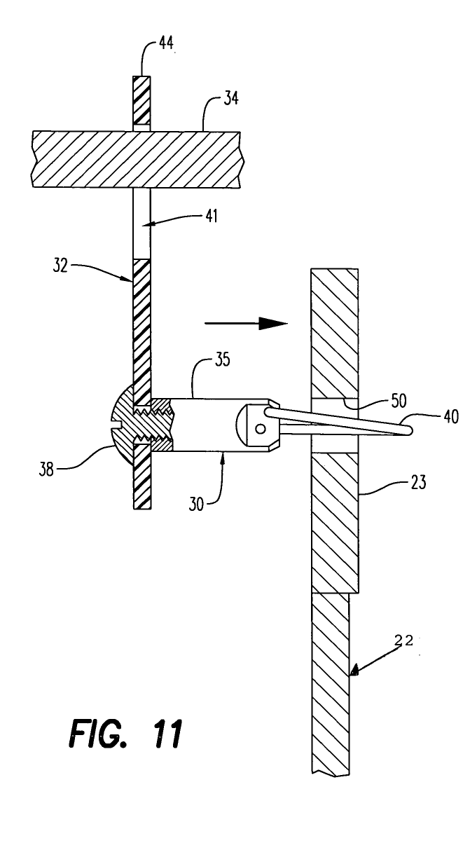

During use of the hanger 31, the shanks 35 and clamps 40 are inserted through openings 50 in the bindings 23 of the chart pads 22 as shown in FIG. 11. The clamps 40 then are pivoted into engagement with the bindings 23 forcing them against the front surface 36 of the frame 32 as shown in FIG. 10. Next, the hanger 31 can be mounted on the easel 26 by passing the rods 33, 34 sequentially through the entrance portions 43 of, respectively, the slots 41, 42 (FIG. 9), through the intermediate portions 45 (FIG. 8), and up into engagement with the upper edges of the terminal portions 46 (FIGS. 6 and 7). A similar procedure can be used to mount additional flip chart pads 22 on the easel 26. The hangers 31 also can be used in a similar fashion to mount flip chart pads 22 on bracket rods (not shown) mounted in any suitable display or storage area.

Obviously, many modifications and variations of the present invention are possible in light of the above teachings. It is to be understood, therefore, that the invention can be practiced otherwise than as specifically described.

What is claimed is:

1. A hanger for display sheets and comprising:
a frame having an upper edge defining a first slot and a second slot spaced from said first slot; at least one of said first and second slots having an entrance portion extending downwardly from said upper edge, an intermediate portion extending in a given direction from said entrance portion, and a terminal portion extending from said intermediate portion upwardly toward said upper edge; and
securing means for attaching display sheets to said frame.

2. A hanger for display sheets according to claim 1 wherein each of said slots has an intermediate edge portion extending in said given direction.

3. A hanger for display sheets according to claim 2 wherein each of said slots defines an entrance portion extending downwardly from said upper edge.

4. A hanger for display sheets according to claim 3 wherein each of said first and second slots is shaped and arranged to receive a support member projecting transversely to said frame.

5. A hanger for display sheets according to claim 4 wherein said frame is elongated in said given direction and said first and second slots are disposed adjacent opposite ends thereof.

6. A hanger for display sheets according to claim 5 wherein said securing means comprises a pair of securing devices spaced apart in said given direction.

7. A hanger for display sheets according to claim 6 wherein each of said securing devices comprises a shank portion, a fastener securing one end of said shank portion to said frame, and a clamp mechanism retained by an opposite end of said shank portion; and said clamp mechanism being operable to clamp display sheets against one surface of said frame.

8. A support system for flip charts and comprising:
a stand having a bottom portion supportable from a support surface and an upper portion having first and second parallel bracket rods;
a frame having an upper edge defining a first slot and a second slot spaced from said first slot; at least one of said first and second slots having an entrance portion extending downwardly from said upper edge, an intermediate portion extending in a given direction from said entrance portion, and a terminal portion extending from said intermediate portion upwardly toward said upper edge; and wherein said first rod extends through said terminal portion of said first slot and said second rod extends through said terminal portion of said second slot; and
securing means for attaching display sheets to said frame.

9. A support system according to claim 8 wherein each of said slots has an intermediate edge portion extending in said given direction.

10. A support system according to claim 8 wherein each of said slots defines an entrance portion extending downwardly from said upper edge.

11. A support system according to claim 10 wherein said frame is elongated in said given direction and said first and second slots are disposed adjacent opposite ends thereof.

12. A support system according to claim 11 wherein said securing means comprises a pair of securing devices spaced apart in said given direction.

13. A support system according to claim 12 wherein each of said securing devices comprises a shank portion, a fastener securing one end of said shank portion to said frame, and a clamp mechanism retained by an opposite end of said shank portion; and said clamp mechanism being operable to clamp display sheets against one surface of said frame.

14. A support system according to claim 8 wherein said bracket rods are disposed in a plane substantially parallel to said support surface.

15. A support system according to claim 14 wherein said frame is elongated in said given direction and said first and second slots are disposed adjacent opposite ends thereof.

16. A support system according to claim 15 wherein said securing means comprises a pair of securing devices spaced apart in said given direction.

17. A support system according to claim 16 wherein each of said securing devices comprises a shank portion, a fastener securing one end of said shank portion to said frame, and a clamp mechanism retained by an opposite end of said shank portion; and said clamp mechanism being operable to clamp display sheets against one surface of said frame.
